(19) United States
(12) Patent Application Publication
(10) Pub. No.: US 2014/0101146 A1
(43) Pub. Date: Apr. 10, 2014

(54) SYSTEM AND PROCESS FOR DISCOVERING RELATIONSHIPS BETWEEN ENTITIES BASED ON COMMON AREAS OF INTEREST

(71) Applicant: THE DUN & BRADSTREET CORPORATION, Short Hills, NJ (US)

(72) Inventors: Anthony J. SCRIFFIGNANO, West Caldwell, NJ (US); Michael KLEIN, Chatham, NJ (US); Sudip CHAKRABORTY, Princeton Junction, NJ (US); Mark STREITMAN, East Brunswick, NJ (US); Adnan AHMED, Watchung, NJ (US); Joseph CASTAGLIOLA, Nazareth, PA (US); Yan DUAN, Jersey City, NJ (US); Andres BENVENUTO, Morristown, NJ (US); Hiu Tai CHAN, Holmdel, NJ (US)

(73) Assignee: THE DUN & BRADSTREET CORPORATION, Short Hills, NJ (US)

(21) Appl. No.: 14/015,259

(22) Filed: Aug. 30, 2013

Related U.S. Application Data
(60) Provisional application No. 61/696,103, filed on Aug. 31, 2012.

(51) Int. Cl. G06F 17/30

(52) U.S. Cl. CPC G06F 17/3053
USPC 707/728

(57) ABSTRACT

A method for generating a relevance score for at least one candidate retrieved in a search, the method comprising: initiating a query seeking at least one the candidate based upon at least one filter selected from the group consisting of: product name, product category, company name, HS code, SIC code and any other product-related qualifier; searching at least one database for matches between the candidate and the filter, thereby generating at least one matched candidate; generating an initial relevance score for each the matched candidate; generating at least one additional score for each the matched candidate, wherein the additional score is at least one selected from the group consisting of: a reputation score, a score boost, a past behavior score, a profile match score, a preference match score and a web behavior score; and generating a final relevance score based upon the initial relevance score and the at least one additional score for each the matched candidate.

CROSS-REFERENCED APPLICATIONS

This application claims priority to U.S. Provisional Application No. 61/696,103, filed on Aug. 31, 2012, which is incorporated herein in its entirety by reference thereto.

### BACKGROUND

1. Field of the Disclosure

The present disclosure generally relates to a system and process for identifying and relating different entities, referred to as counter-parties or candidates, based on common areas of interest, and to utilize one or more criteria and related values to identify the counter-parties or candidates that are of greatest common interest as determined by those criteria and related values.

2. Related Prior Art

There are many products (referred to as “solutions”) used in the current market to associate one party to another party. Two common examples include “dating” and similar social applications in which one party can identify other parties based on a series of predefined or user-entered criteria, and “e-commerce” applications in which a party acting as a buyer can identify other parties acting as a seller or supplier based on information regarding products or services, or vice versa. These current solutions accept a transactional inquiry as it is entered by a user, being either an individual or a system, and use data for that inquiry to query data sources for entries that contain the inquiry values or values similar to that inquiry value. Responses to these inquiries may also consider information about each party, such as reviews provided by one or more same or other parties based on prior experiences with either counter-party or candidate.

Using e-commerce applications as an example, these existing solutions provide relatively simplistic capabilities, as follows. For example, these existing solutions are limited to searching for values that are similar in format, e.g., contain the same text characters, as the inquiry and have limited contextual understanding of the inquiry beyond the actual data within the inquiry. In addition, these existing solutions do not include the capability for the inquiring party to define a range of industry-standard or previously-defined and accessible values to widen or limit the inquiry value beyond the inquiry data, such as product category or other approach to organizing products into groups. In addition, these current solutions do not include the capability of either party to define characteristics of potential contra-parties, such as industry code, geography, financial viability, or ability to deliver.

In addition, existing solutions do not include information from an objective third party that is based on historical transactional and financial information to provide insight as to the financial and operational viability of either party, and the overall trust-worthiness of each party based on an independent accumulation and analysis of such data. Where this type of information is made available to the counter-party or candidate, it is based on subjective reviews that are provide by parties that have had a prior relationship with that counter-party or candidate, and which in many cases has been provided by the counter-party or candidate itself. In addition, using e-commerce as the example, this relates only to the seller or supplier party, and does not consider the history of the buyer counter-party or candidate which may be valuable information to the seller in determining interest in engaging in a financial transaction.

The lack of this data being provided by an objective third party which has a widely accepted reputation for making such assessments based on data such as trade experiences, years in business, financial viability which defines credit worthiness, and historical business or financial activity which demonstrates a propensity for fraud, may increase the likelihood of parties entering into unfavorable future transactions, as well as be used as a determining factor in deciding the characteristic of a transaction such as size of the transaction and closing dates. In addition, these existing solutions do not provide the capability for each party in a potential transaction to have access to identity, financial, and other non-reviewed information about the counter-party or candidate which could be used by either party to determine whether to conduct business with the other party.

In addition, these existing solutions do not categorize each party into groups based on identity data, including but not limited to, size, industry, and areas of interest, or prior transactional data, including but not limited to historical financial transactions and payment information where the party may have acted as a buyer or seller, as a factor in determining the propensity for either party to be interested in transacting with the other party based on product or groups of products, or to have completed a financial transaction based on third party analysis of those types of prior transactions.

The present disclosure is for a global solution focused on e-commerce, but can be used in other applications that do not include a commercial capability. This includes the ability to accept and process inquiries based on common areas of interest such as products or groups of products between two counter-parties or candidates, independent of country, language, or writing system, executed on an open technology platform and implemented to encourage cross-border transactions. The present disclosure seeks to overcome the various disadvantages of current products, through the execution of flexible, customizable, and scalable approaches to resolve inquiries.

### SUMMARY

A method for generating a relevance score for at least one candidate retrieved in a search, the method comprising: initiating a query seeking at least one the candidate based upon at least one filter selected from the group consisting of: product name, product category, company name, HS code (a value defined by the Harmonized Commodity Description and Coding Systems, generally referred to as “Harmonized System” or simply “HS Code”, as a standardized numerical method of classifying traded products developed and maintained by the World Customs Organization), SIC code and any other product-related qualifier; searching at least one database for matches between the candidate and the filter, thereby generating at least one matched candidate; generating an initial relevance score for each the matched candidate; generating at least one additional score for each the matched candidate, wherein the additional score is at least one selected from the group consisting of: a reputation score, a score boost, a past behavior score, a profile match score, a preference match score and a web behavior score; and generating a final relevance score based upon the initial relevance score and the at least one additional score for each the matched candidate.

The method further comprising: outputting a listing of the matched candidates with the final relevance scores. The method further comprises: sorting the listing of the matched candidates according to the relevance score.

The candidate is preferably a buyer, further comprising passing the matched candidate through a look alike engine prior to generating the initial relevance score for the matched candidate.

The searched database is preferably at least one selected from the group consisting of objectively assessed business entity data, application data that is accumulated for the specific use of this application, and data from other sources with associated product and other codes such as SIC.

The initial relevance score is optionally generated from a search engine that is used to identify an initial candidate list based on the inquiry value. The score boost is determined by the objective assessment as the operational and financial quality and the party and its status of registration within the application that is used to process these inquiries.

The reputation score is determined by at least one score selected from the group consisting of: a commercial credit score, a financial stress score, and detail trade. The preference match score is calculated by the sum of a first score which is determined by whether a business is bookmarked (1) or not (0), and a second score which is determined by whether the business is connected to the business which has initiated the query, and results in a value of +1 or 0.The past behavior score is based upon the matched candidate's shipment volume.

The method further comprising a step of generating a relevance index for each candidate prior to the step of generating the initial relevance score.

A computer readable storage media containing non-transitory computer executable instructions which when executed cause a processing system to perform a method comprising: initiating a query seeking at least one the candidate based upon at least one filter selected from the group consisting of: product name, product category, company name, HS code, SIC code and any other product-related qualifier; searching at least one database for matches between the candidate and the filter, thereby generating at least one matched candidate; generating an initial relevance score for each the matched candidate; generating at least one additional score for each the matched candidate, wherein the additional score is at least one selected from the group consisting of: a reputation score, a score boost, a past behavior score, a profile match score, a preference match score and a web behavior score; and generating a final relevance score based upon the initial relevance score and the at least one additional score for each the matched candidate.

A system for providing enhanced matching for database queries, the system comprising: a processor; and a memory that contains a program that cause the processor to: initiate a query seeking at least one the candidate based upon at least one filter selected from the group consisting of: product name, product category, company name, HS code, SIC code and any other product-related qualifier; search at least one database for matches between the candidate and the filter, thereby generating at least one matched candidate; generate an initial relevance score for each the matched candidate; generate at least one additional score for each the matched candidate, wherein the additional score is at least one selected from the group consisting of: a reputation score, a score boost, a past behavior score, a profile match score, a preference match score and a web behavior score; and generate a final relevance score based upon the initial relevance score and the at least one additional score for each the matched candidate.

The present disclosure includes a solution that includes the following primary activities: (1) accept an inquiry from parties interested in acting as buyer, seller, or both types of counter-party or candidate based on product or groups of products, (2) process information about the party and product based on a database of qualified information regarding parties and products, (3) identify counter-party or candidate candidates based on similarities between the requested product or group of products and those products and groups of products which can be provided by another party, (4) identify other counter-party or candidate candidates based on business identity data similarities between counter-parties or candidates using a “look alike” concept which consider structural, organizational, operational, financial, and other characteristics that are common across multiple parties, (5) sequence the presentation of counter-parties or candidates that can meet the request of the initiating party based on product information as well as objective data regarding the financial viability and other historical information regarding each counter-party or candidate that is based on data maintained and qualified by an objective third-party, and (6) provide information to each counter-party or candidate regarding the other counter-party or candidate which can be used as insight to determine if a potential transaction is desirable.

This includes logic to interpret and contextually infer values from each inquiry to identify counter-party or candidates and their structural, organizational, operational, financial, and other characteristics that are on data repositories against which the inquiries are processed, and which are maintained and qualified by an objective third-party regarding each party's historical structural, organizational, operational, financial, and other characteristics indicating historical and current financial viability, and related 3^{rd}-party assessments and opinions of each party's financial and operational ability to satisfy a future transaction and meet their committed obligations based on that data and related analytics. This includes the capability for the inquiring party to use this type of data, as well as define a range of industry-standard or previously-defined and accessible values to widen or limit the inquiry value, such as product or product category, or characteristics to limit potential counter-parties or candidates, such as industry code, geography, or size, to identify desirable counter-parties or candidates.

In addition, the method and system of the present disclosure has the capability for each party that uses the solution to provide profile information about itself, including identity data and data that demonstrates the structural, organizational, operational, and financial viability of the party, as well as other characteristics of the party. Further, this includes the ability of such data to be validated by an objective third-party, based on data provided by multiple sources and assessed against quality-based logic, including, but not limited to, trade and other transactional information, relationships across business entities (often referred to as “linkages” or “hierarchies”), and current status for example to indicate if the entity is currently operational.

The present disclosure provides this capability using a range of criteria, including information about each party as determined by an objective third party which has a widely accepted reputation for making such objective assessments, and information about similarities in products and groups of products for other counter-parties or candidates in a potential transaction, to develop a relevance score which is used to sequence the results of each inquiry. A “relevance score” is a calculated value which indicates the degree to which the results of an inquiry are similar to the inquiry itself. This score is comprised of multiple characteristics including, but not limited to, both counter-parties or candidates and products (i.e. which is requested and what is available), to sequence the results of an inquiry initiated by a counter-party or candidate so that the results are presented in a sequence and manner which is most likely to satisfy the requesting party. In addition, each party in a potential transaction would have access to identity, financial, and other information about the contra-party, as well as the relevance score, which could be used by either party to determine whether to conduct business with the other party.

The present disclosure also includes a “look alike” capability to categorize each party into groups based on similarities across types of information, such as size, industry, areas of interest, and historical financial transactions as a factor in determining a potential specific buyer's propensity to be interested in a product or to make certain types of purchases, in order to identify other potential counter-parties or candidates such as potential buyers for a supplier for a specific product or group of products.

The system and method also provides opinions or insights as to the degree to which the responses to each inquiry are similar to the inquiry data, including similarities in characteristics of each party on both sides of the transaction.

### BRIEF DESCRIPTION OF THE DRAWINGS

FIG. 1 is a flow chart of the process according to the present disclosure.

FIG. 2 is a block diagram of a system according to the present disclosure.

FIG. 3 is a flow diagram of a buyer search on sellers.

FIG. 4 is a flow diagram of a seller search on buyers.

FIG. 5 is a graph which depicts various searches according to the present disclosure.

FIG. 6 is a block diagram of a system wherein sellers are searching for buyers.

FIG. 7 is a block diagram of a system wherein buyers are searching for sellers.

FIG. 8 is a graph depicting a series of queries, display categories, HS codes and SIC codes.

FIG. 9 is a block diagram of a first level product matching according to the present disclosure.

FIG. 10 is a block diagram of a second level product matching according to the present disclosure.

FIG. 11 is a block diagram of a third level product matching according to the present disclosure.

FIG. 12 is a graph demonstrating Relevance Index according to the present disclosure.

FIG. 13 is a logic diagram depicting the work flow in determining a relevance score according to the present disclosure.

FIGS. 14-22 are a series of tables which demonstrate the relevance score and how the various scores are generated, i.e. initial relevance score, reputation score, score boost, past behavior score, profile match score, preference match score, and web behavior score.

### DETAILED DESCRIPTION OF THE PREFERRED EMBODIMENTS

The present disclosure is, for example, capable of connecting buyers with sellers in emerging markets for easier, faster, and more effective cross border trade experience. The disclosure can be used for other purposes to associate different parties based on common areas of interest, such as dating systems, interest in specific books or categories of literature, world geography, or hobbies such as cooking or gardening.

The present disclosure enables parties to get a listing of counter-parties or candidates that meet inquiry criteria which is use to initiate a search by clicking on a selection tab, for example “Search by Product” or “Search by Product Category”, or by entering Free Text for the product name/description of interest. As this relates to sellers searching for buyers, this enables the selling party to search buyer-parties based on the products which are of interest to the buying-party and which can be provide by the selling-party. In addition to using this inquiry data to identify potential counter-parties or candidates, this takes into account information regarding each counter-party or candidate and search results are then ranked based on similarity (referred to as “relevance”) of the inquiry data and data found on the database, as well as information about each counter-party or candidate, for example attributes such as the following: (i) prior transaction activity; (ii) registration status of the party within the application that is processing the transaction, (iii) web-behavior related to previous experiences with each party such as (1) product clicks; (2) business clicks; (3) search behavior; and (4) bookmarks; and (iv) trustworthiness of the buyer based on independent third party review of information regarding each counter-party or candidate related to their structural, organizational, operational, financial, and other characteristics indicating historical and current financial viability, as well as third party assessments and opinions of each party's financial and operational ability to satisfy a future transaction and meet their committed obligations based on that data and related analytics.

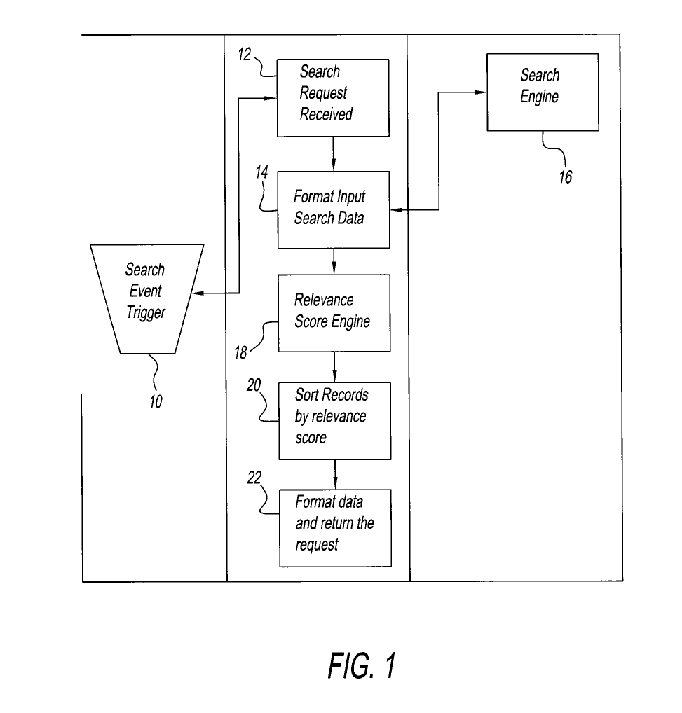

FIG. 1 is a block diagram which depicts the work flow of the present disclosure, wherein search event trigger 10 generates a search request, for example, a company name, product or product code. This trigger is sent to the server where the search request is received 12 and the format input search data 14 is obtained from a search engine 16 based upon the search request. Thereafter, a list of counter-parties or candidates generated by search engine 16 are passed through a relevance score engine 18, wherein each candidate is provided with a unique relevance score. Thereafter, the records or candidates are sorted by their relevance score 20 and returned to the user or requestor 22.

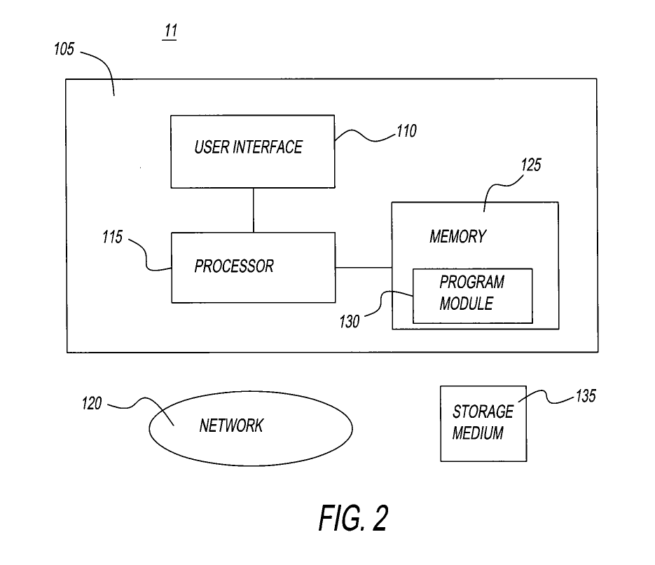

FIG. 2 is a block diagram of a system 100, for employment of the present invention. System 100 includes a computer 105 coupled to a network 3930, e.g., the Internet. Computer 3905 includes a user interface 110, a processor 115, and a memory 120.

Computer 105 may be implemented on a general-purpose microcomputer. Although computer 105 is represented herein as a standalone device, it is not limited to such, but instead can be coupled to other devices (not shown) via network 130.

Processor 115 is configured of logic circuitry that responds to and executes instructions.

Memory 120 stores data and instructions for controlling the operation of processor 115. Memory 120 may be implemented in a random access memory (RAM), a hard drive, a read only memory (ROM), or a combination thereof. One of the components of memory 120 is a program module 125.

Program module 125 contains instructions for controlling processor 115 to execute a method for generating a relevance score each buyer or seller candidate, the method comprising: initiating a query seeking at least one the candidate based upon at least one filter selected from the group consisting of: product name, product category, company name, HS code, SIC code and any other product-related qualifier; searching at least one database for matches between the candidate and the filter, thereby generating at least one matched candidate; establishing a baseline relevance index for each the matched candidate; calculating an initial relevance index; updating the initial relevance score for each the matched candidates by revising the initial relevance score by combining it with at least one additional score selected from the group consisting of: a reputation score, a score boost, a past behavior score, a profile match score, a preference match score and a web behavior score; and calculating a final relevance score for each the matched candidates.

The term “module” is used herein to denote a functional operation that may be embodied either as a stand-alone component or as an integrated configuration of a plurality of sub-ordinate components. Thus, program module 125 may be implemented as a single module or as a plurality of modules that operate in cooperation with one another. Moreover, although program module 125 is described herein as being installed in memory 120, and therefore being implemented in software, it could be implemented in any of hardware (e.g., electronic circuitry), firmware, software, or a combination thereof

User interface 110 includes an input device, such as a keyboard or speech recognition subsystem, for enabling a user to communicate information and command selections to processor 115. User interface 110 also includes an output device such as a display or a printer. A cursor control such as a mouse, track-ball, or joy stick, allows the user to manipulate a cursor on the display for communicating additional information and command selections to processor 115.

Processor 115 outputs, to user interface 110, a result of an execution of the methods described herein. Alternatively, processor 115 could direct the output to a remote device (not shown) via network 130.

While program module 125 is indicated as already loaded into memory 120, it may be configured on a storage medium 135 for subsequent loading into memory 120.

Storage medium 135 can be any conventional storage medium that stores program module 125 thereon in tangible form. Examples of storage medium 135 include a floppy disk, a compact disk, a magnetic tape, a read only memory, an optical storage media, universal serial bus (USB) flash drive, a digital versatile disc, or a zip drive. Alternatively, storage medium 135 can be a random access memory, or other type of electronic storage, located on a remote storage system and coupled to computer 105 via network 130.

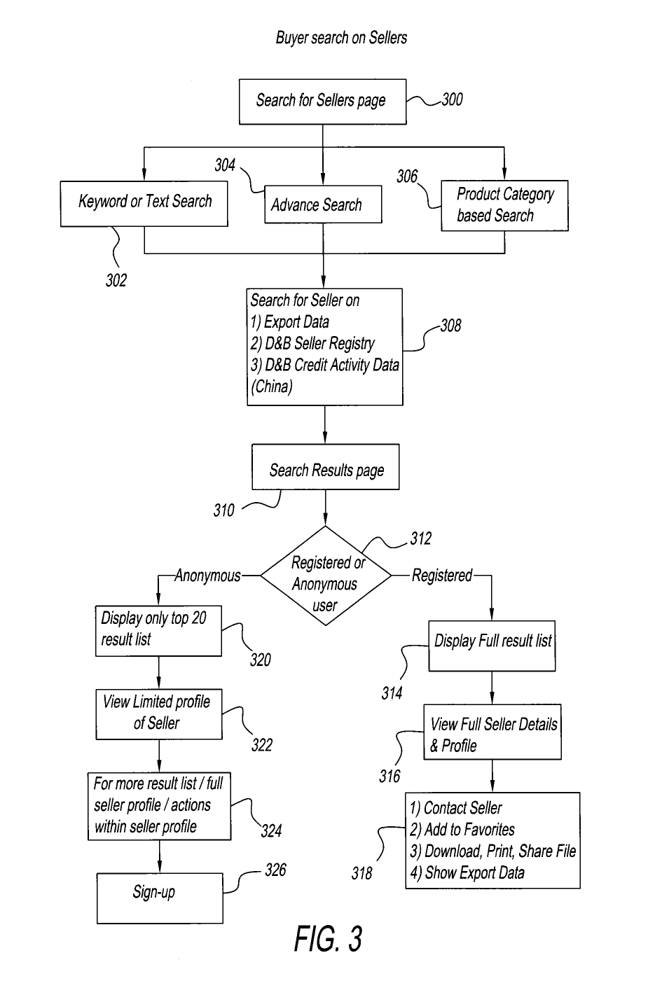

FIG. 3 is a logic diagram depicting the work flow when a buyer searches for a seller. Initially, buyer will search for a seller's page 300 by conducting either a keyword or test search 302, advanced search 304 and/or a product category search 306. The system then searches for sellers on at least one database 308, e.g., seller registry, credit activity data, etc., wherein the results are presented on a search results page 310. The system then seeks to determine whether the buyer has registered on the databases which are used in this application, since that information will provide information to assess characteristics of the buyer such as structural, organizational, operational, financial, and other characteristics indicating historical and current financial viability 312. If the buyer is a registered user, then a full result list regarding its products and information about the buyer itself is displayed 314. In addition, a view of the full seller details and profile are provided 316 which may then be used by the buyer to contact the seller, add to favorites, download, print, and/or share the file and show export data 318. If the buyer is not registered on the databases (referred to as being “anonymous”), then the system only displays only a subset of the results list 320 and provides only a limited view of the seller 322, while offering to allow buyer to see a complete listing of results 324 if they become registered by signing up 326.

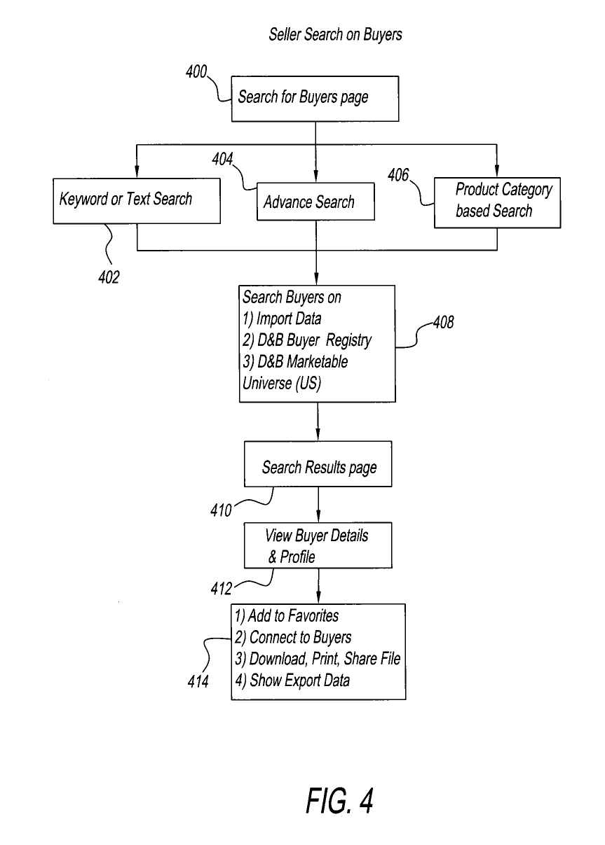

FIG. 4 is a logic diagram depicting the work flow when a seller searches for a buyer. Initially, seller will search for a buyer's page 400 by conducting either a keyword or test search 402, advanced search 404 and/or a product category search 406. The system then searches for buyers on at least one database 408, e.g., export data, buyer registry, credit activity data, etc., wherein the results are presented on a search results page 410. The system then provides a view of the full seller details and profile are provided 412 and the seller may contact the buyer, add to favorites, download, print, and/or share the file and show export data 414.

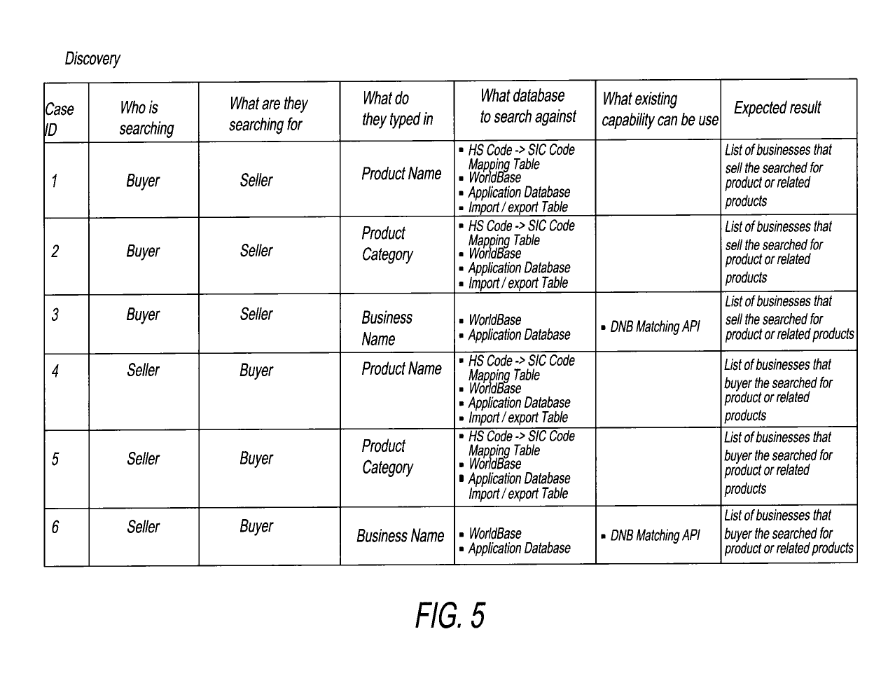

FIG. 5 is a graph which depicts various searches according to the present disclosure. For example, Case ID 2 depicts a buyer looking for a seller in a particular product category using HS codes, SIC does, etc. in order to get a list of potential businesses that sell the searched for product or related products.

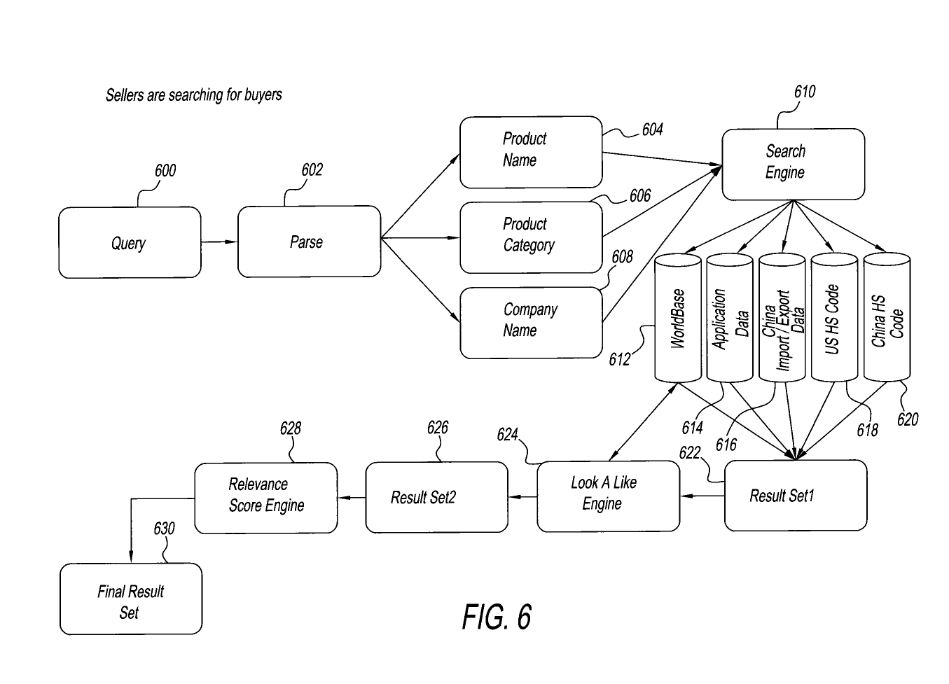

FIG. 6 is a block diagram of the system according to the present disclosure when a seller is searching for buyers. At the outset, a seller will enter a query 600 which is then parsed 602 into components to provide a large number of responses, such as product name 604, product category 606 and company name 608 before sending to a search engine 610. The search engine will seek to match the product name 604, product category 606 and/or company name 608 to data retrieved and/or stored in various databases, e.g., corporate entity database 612, application data 614, data from external sources, such as import/export data 616, domestic HS Code data 618, and foreign HS Code data 620. Matches will be output as result sett (622) and then forwarded to a look-alike engine 624 to identify other counter-parties or candidates that may also be of interest to the initiating party based on similarities between the parties, such as structural, organizational, operational, financial, and other characteristics indicating historical and current financial viability. Look alike engine 624 then outputs result set2 (626) which is processed via a relevance score engine 628. The relevance score engine 628 will use multiple types of data and analytics to generate relevance scores for each candidate forwarded via result set2 (626), thereby generated a final result set 630 which lists each candidate in order or its relevance score or according to any other parameters set in the program.

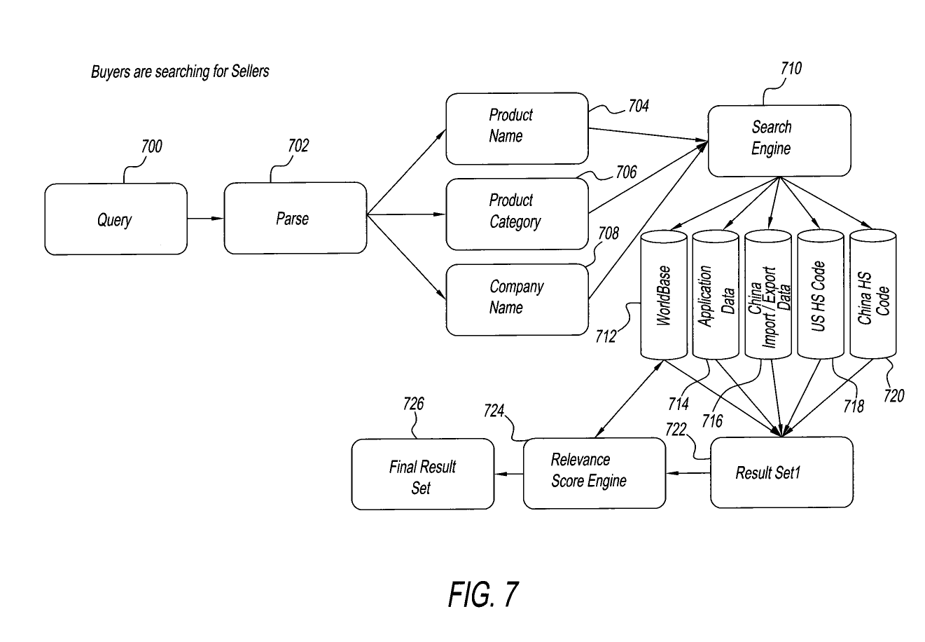

FIG. 7 is a block diagram of the system according to the present disclosure when a buyer is searching for sellers. At the outset, a buyer will enter a query 700 which is then parsed 702 into product name 704, product category 706 and company name 708 before sending to a search engine 710. The search engine will seek to match the product name 704, product category 706 and/or company name 708 to data retrieved and/or stored in various databases, e.g., corporate entity database 712, application data 7614, data from other sources, such as import/export data 716, domestic HS Code data 718, and foreign HS Code data 720. Matches will be output as result sett (722) which is processed via a relevance score engine 724. The relevance score engine 724 will generate relevance scores for each candidate forwarded via result sett (722), thereby generated a final result set 726 which lists each candidate in order or its relevance score or according to any other parameters set in the program.

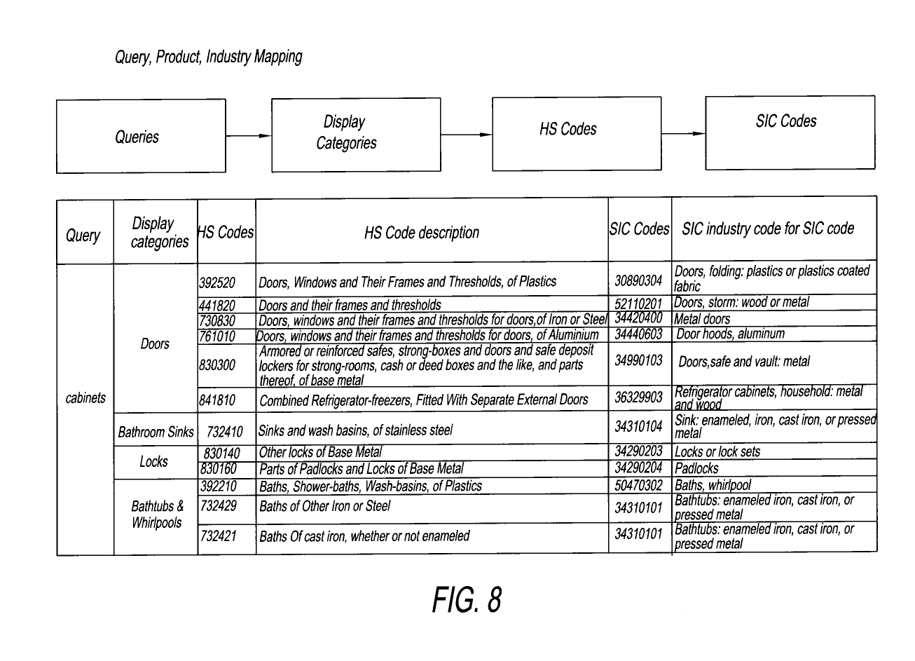

FIG. 8 provides examples of various product queries which can be generic, e.g., cabinets, and then indicates how these generic values can be used to generate related values, e.g. doors, bathroom sinks, locks and bathtubs and whirlpools, to identify more candidates that may be of interest to the inquiring party. This includes the use of predefined relationships such as standard HS Codes, HS Code descriptions, SIC Codes and SIC industry code for SIC Codes, as well as inferred values, for example to consider both bathroom and kitchen cabinets for the inquiry term “cabinets”.

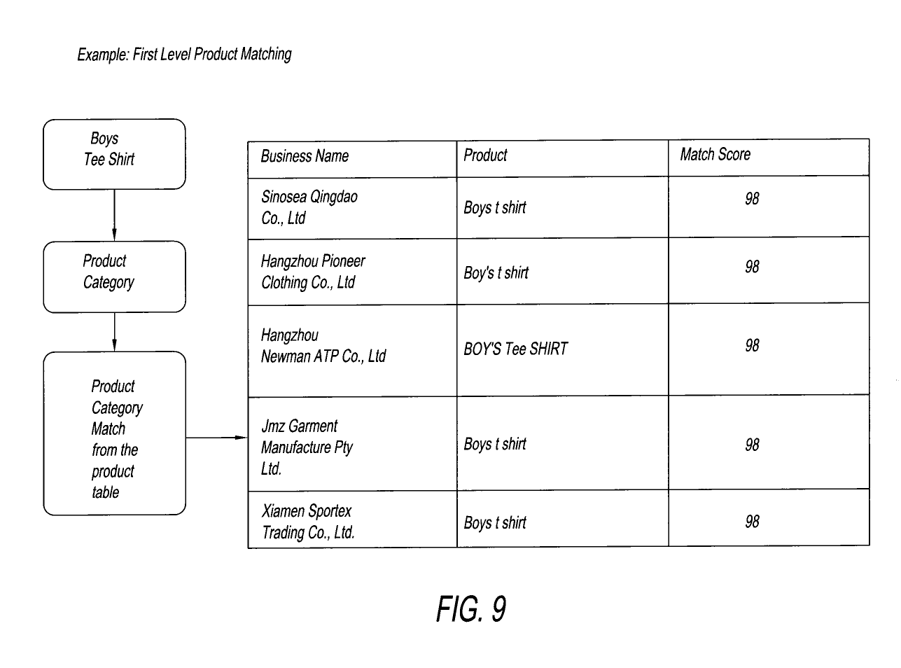

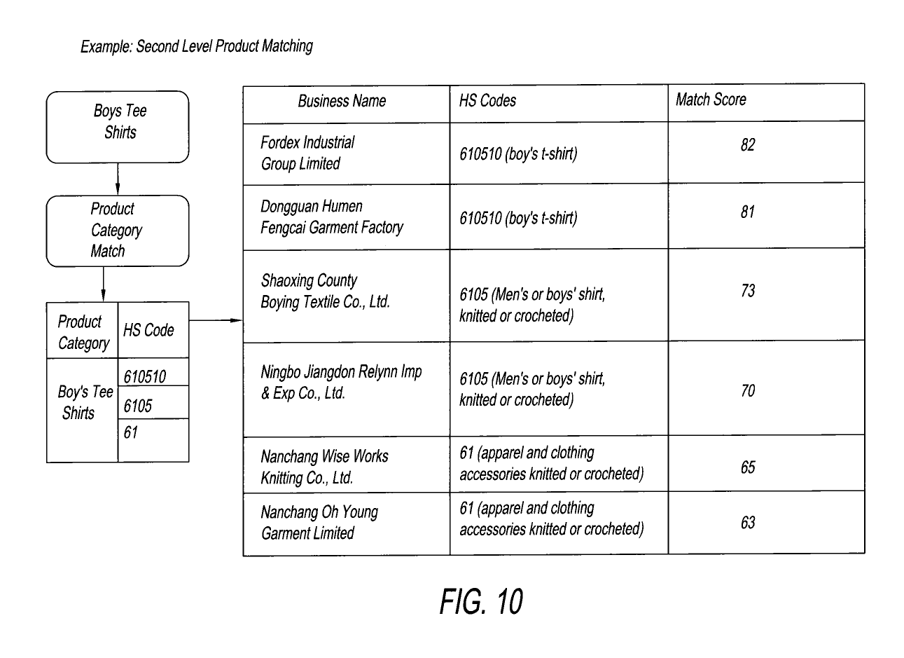

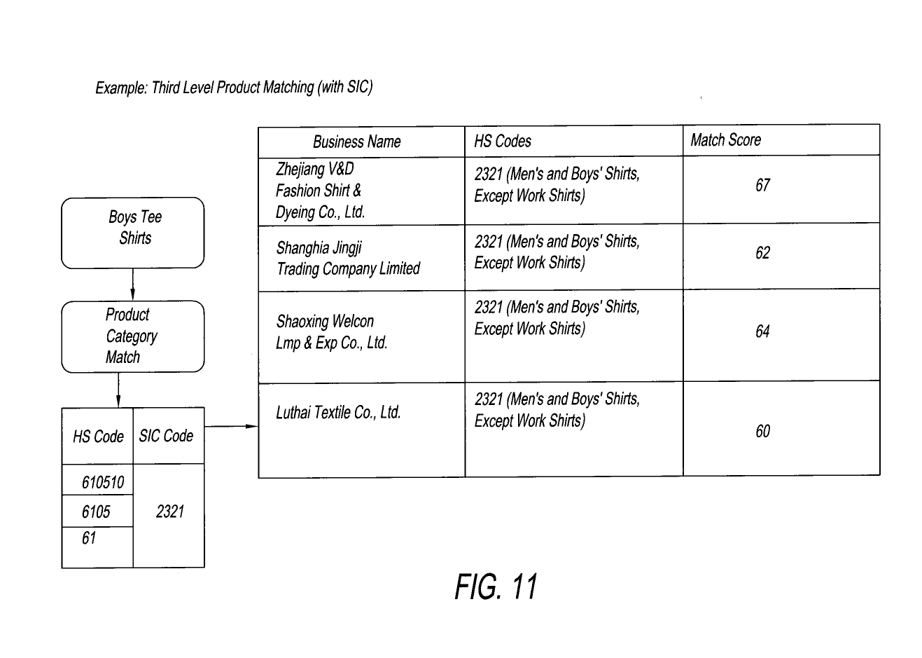

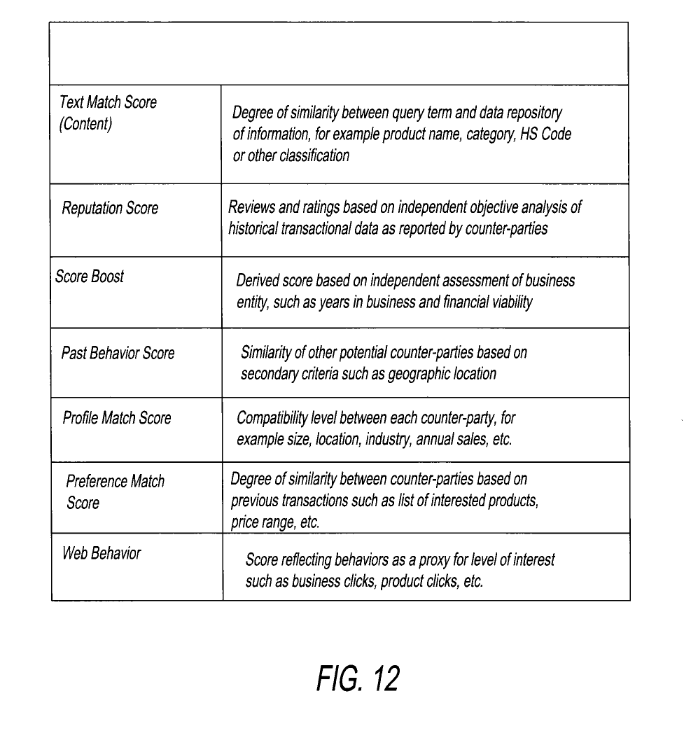

FIGS. 9-11 provide examples of first, second and third level product matching according to the present disclosure using product, HS Codes, and SIC Codes, respectively.

### Relevance Index

The relevance algorithm of the present disclosure is computed by using several different numbers, based on predefined weighting algorithms.
1. The baseline relevance score is generated using a series of algorithms which assess and determine relative similarity between the inquiry and candidates on a database of qualified data using logic to associate products and tables of product associations, for example, products categories and HS codes.
2. The baseline relevance score is converted to a score in the range of 3 to 12 (this number is the initial relevance score).
3. The Score Boost is weighted, and it is determined by the a predefined assessment of the quality of each counter-party or candidate, using objective criteria to assess parties based on financial, operational, and similar characteristics; for example, the DUN & Bradstreet Corporation's DUNSRight quality process. This also considers the status of registration of each counter-party or candidate, based on whether or not they have provided information about their structural, organizational, operational, financial, and other characteristics indicating historical and current financial viability which is then retained on the database that is used in this invention. That determines the Score Boost is within a predefined range, for example between +2 and −2.
4. The Reputation Score is determined by a series of scores associated to the financial and operational condition of the party as determined by an objective third party based on financial and other information about the party, for example commercial credit score (CCS), financial stress score (FSS), and detail trade PayDex number, and assigned based on a predefined tables and weightings of relative impact. Depending on each value, the output will be in a predefined range, for example, between +3 to −2. These values are then used to calculate the Reputation Score.
5. To calculate the baseline Relevance Index, we calculate the percent quintiles to break them into five different bands, and then we assign the initial relevance score to each band.
6. The Preference Match Score is based on the degree of similarity between the inquiring party and the candidate counter-party or candidate, based on their previous interest in products, price ranges, and other similar information which is a proxy to indicate their financial preferences. This may include “bookmark” to indicate whether the counter-parties or candidates have had prior financial transactions. The Preference Score Match is defined as a range, for example, between +1 and 0.

7. Past Behavior Score is a special score that is not based on weight. It is dependent on a candidate's past shipment volume. For example, if the shipment volume for Company A is 544, then we will use log based 10 to transform the volume to a score, e.g., log₁₀ (544)=2.74. Therefore, we get a 2.74 relevance score for this section.

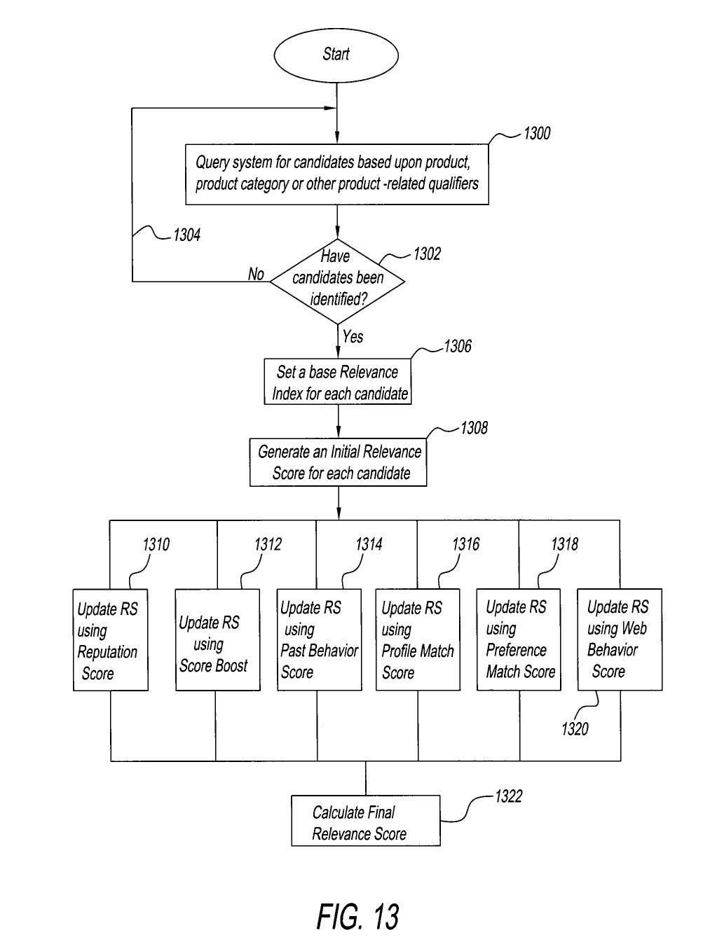

FIG. 13 is a logic diagram demonstrating how a relevance score is generated for each candidate derived from a query initiated by either a party, e.g., buyer or seller, pursuant to the present disclosure. According to the present disclosure, a party queries the system for candidates 1300 based upon a product, product category or other product-related qualifier. If no candidates have been identified 1302 based upon the product, product category or other product-related qualifier, then the system will prompt the party to enter another query 1304. However, if candidates have been identified, then the system generates a baseline relevance index (band) for each candidate identified 1306. The system thereafter generates or calculates an initial relevance score for each candidate 1308 which fits within at least one band of the baseline relevance index. The system then seeks to update the initial relevance score (RS) by updating each score by calculating and adding at least one of the additional scores to the initial relevance score, e.g., a reputation score 1310, a score boost 1312, a past behavior score 1314, a profile match score 1316, a preference match score 1318, and a web behavior score 1320. A final relevance score 1322 is then calculated by adding all of the scores from 1310-1320 to the initial relevance score.

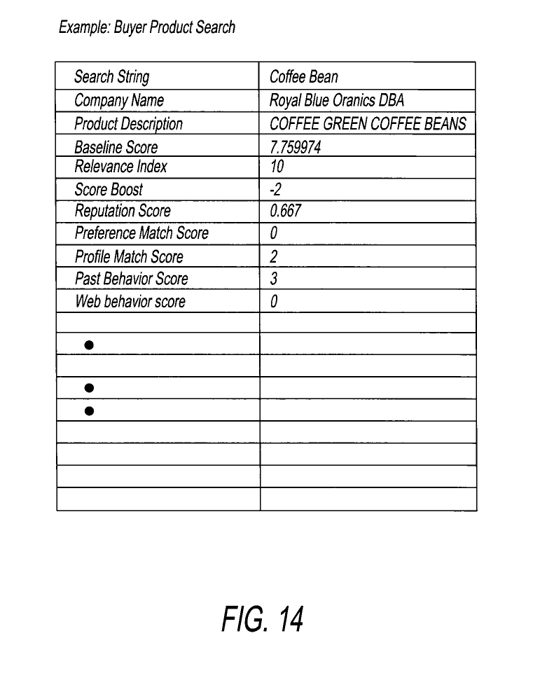

FIGS. 14-22 are a series of tables which are used to exemplify how a relevance score is calculated according to the present disclosure when a buyer undertakes a product search, for example, coffee beans. The example is best describe by referring to FIGS. 13-22, wherein step 1300 of FIG. 13 provides for a party (e.g., seller or buyer) to submit a query to identify one or more counter-parties or candidates based on a common area of interest is initiated by on line-line (manually entered) or automated inquiry, for one or more inquiries. For this example, the common area of interest is a product, which may be expressed as a specific product name (and provide by a free-form entry value or as a pull-down from a list), product category, product grouping, an associated industry classification (code or name), or other values. This is referenced to as a “search term”; examples may include:
Product name: coffee beans (unground)
Product category: beverage
Product grouping: breakfast beverages (hot)

This inquiry value is compared to tables of known values to extend the range of values that will be used to identify counter-parties or candidates which can provide this product. In addition this value may be analyzed using common routines, such as edit distance and other inference processes to extend the range of values.

Example inquiry value: COFFEE BEANS (see FIG. 14)

As shown in FIG. 13 step 1302, a database of counter-parties that are associated to products is searched to identify counter-parties that may be of interest to the inquiring party based on inquiry value of product; the search tool or algorithm (referred to as “search tool”) may be an existing third-party product or a custom-developed solution. This database may include both parties that have self-registered to be on the database and parties that have been identified via other processes (outside of this invention), such as purchased vendor lists, internet inquiries, or other acquired data such as transactional data using import/export or other data sources. If no candidates are identified a message is provide back to the inquiring party.

Example found value: Coffee—Green Coffee Beans

### Name: Royal Blue Organics

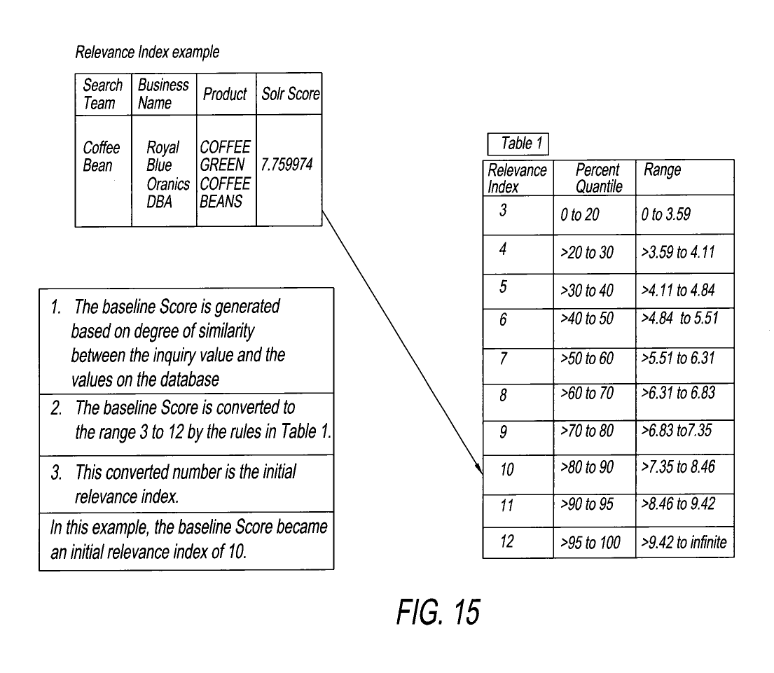

As shown in FIG. 15 and in step 1306 of FIG. 13, for each identified candidate a “relevance index” is set or calculated by the search tool based on multiple criteria related to the degree related to the degree of similarity between the inquiry (“search term”) and the database values. The logic to determine that degree of similarity is not based on a specific search tool; any existing tool can be used or a new tool developed, and the relevance index based on the logic within the tool to determine acceptable degrees of similarity as expressed by a numeric referred to as the “relevance index”.

For example: relevance index=7.759974

As shown in FIG. 15 and steps 1036 and 1308, the “relevance index” is used to set or calculate an “initial relevance score” which is determined based on a pre-defined table that maps “relevance indexes” to “initial relevance scores”:

Pre-defined mapping table:

| Relevance Index range | Baseline relevance score |
|---|---|
| 0-3.59 | 3 |
| 3.6-4.11 | 4 |
| 4.12-4.84 | 5 |
| 4.85-5.51 | 6 |
| 5.52-6.31 | 7 |
| 6.32-6.83 | 8 |
| 6.84-7.35 | 9 |
| 7.36-8.46 | 10 |
| 8.47-9.42 | 11 |
| 9.43-infinite | 12 |

Initial relevance score = 10

As shown in steps 1310-1320 of FIG. 13, the party that is retrieved from the search based on product (in this example “Royal Blue Organics”) is processed through a series of sequential assessment steps in order to adjust the “initial relevance score”. This “initial relevance score” will be converted to a “final relevance score” based on subsequent steps which will increase and decrease the “initial relevance score”; this can result from simple mathematical actions, algorithms, weightings, or any approach which reflects information about the two counter-parties or candidates (i.e., the party that initiated the inquiry) and the party resulting from the search (“Royal Blue Organics”) that indicates the degree to which the counter-party or candidate may be of interest to the inquiring party in terms of the desired product (coffee beans). These steps are presented as examples; the present disclosure considers qualities and characteristics of either or both party which would result in the execution of one or more of these steps or potentially other steps related to either or both of the parties.

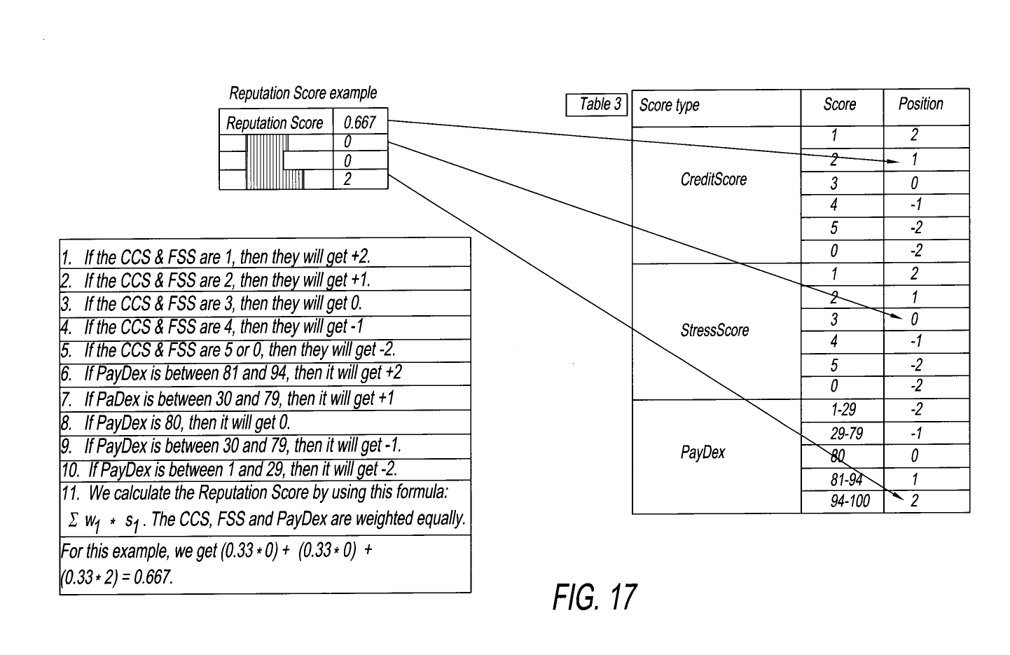

As shown in FIG. 17 and in step 1310 of FIG. 13, the Reputation Score is determined by a series of scores associated with the financial and operational condition of the party as determined by an objective third party based on financial and other information about the party, for example commercial credit score (CCS), financial stress score (FSS), and detail trade PayDex number. Each of these values scores will be assigned a weight based on a predefined table, with the “reputation score” calculated based on the relative value of each component score, with a final score used to adjust the “baseline relevance score”.

For example:

| Score type | Score | Weighting |
|---|---|---|
| CCS | 1 | 2 |
| | 2 | 1 |
| | 3 | 0 |
| | 4 | −1 |
| | 5 | −2 |
| FSS | 1 | 2 |
| | 2 | 1 |
| | 3 | 0 |
| | 4 | −1 |
| | 5 | −2 |
| PayDex | 1-29 | 2 |
| | 29-79 | 1 |
| | 80 | 0 |
| | 81-94 | −1 |
| | 94-100 | −2 |
| CCS | FSS | PayDex |
| 35% | 40% | 25% |

Reputation score = ((1*.35) + (2*.4) + (−1*.25)) = .25 + .8 + (−25) = .9
Updated relevance score = 10 + .9 = 10.9

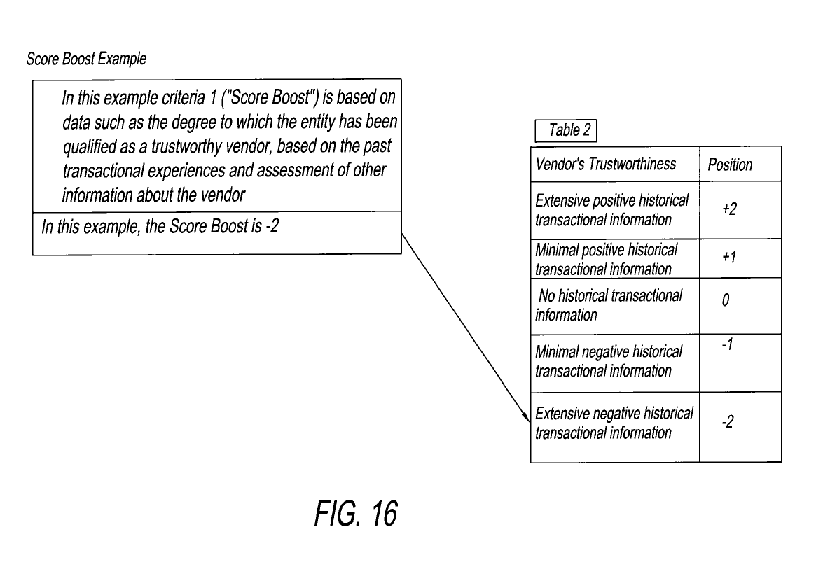

As shown in FIG. 16 and step 1312 of FIG. 13, the Score Boost is derived based on independent assessment of business entity status and stability, using objective criteria related to financial, operational, and similar characteristics, for example as determined by The DUN & Bradstreet Corporation's DUNSRight quality process. This also considers past transactional experiences and assessment of other information about the vendor, as a proxy for assessing the party's ability to satisfy future transactions and meet committed obligations based on that data and related analytics. This metric is a score based on an assessment of these characteristics.

For example:

| Criteria | Score |
|---|---|
| Extensive positive historical transactional information | 2 |
| Limited positive historical transactional information | 1 |
| No historical transactional information | 0 |
| Limited negative historical transactional information | −1 |
| Extensive negative historical transactional information | −2 |

Score boost = 1
Updated relevance score = 10.9 + 1 = 11.9

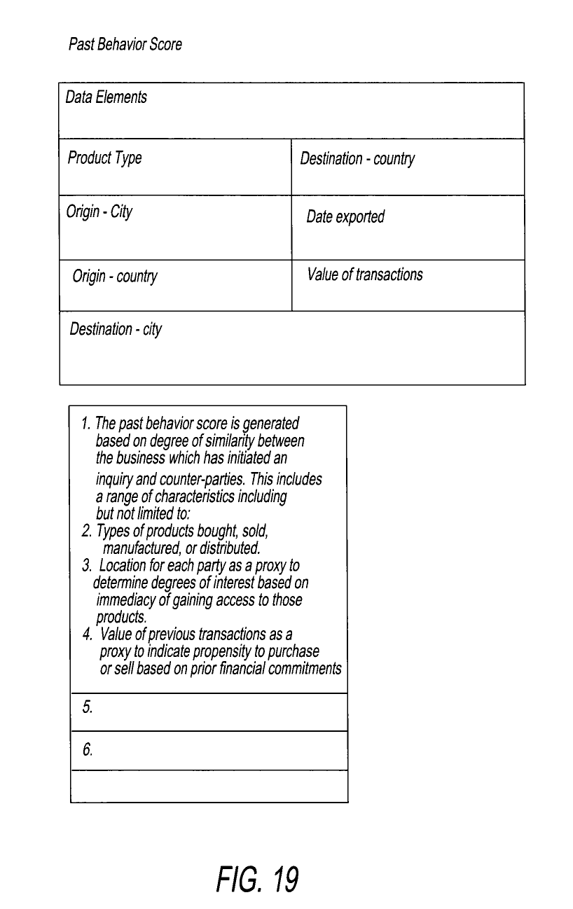

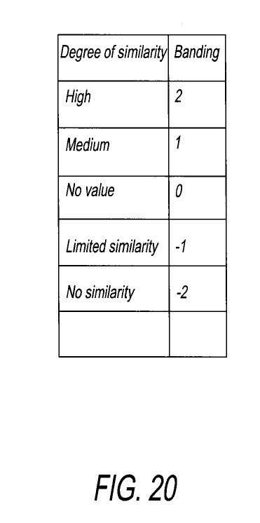

As shown in FIGS. 19 and 20 and step 1314 of FIG. 13, the past behavior score is generated based on degrees of similarity in historical transaction history between the party which has initiated an inquiry and counter-parties or candidates. This is a proxy to indicate how inclined the parties are to engage in a new transaction based on the types, frequency, and recency of engaging in prior transactions. This includes a range of characteristics including but not limited to:
Types of products brought, sold, manufactured, or distributed
Historical shipment/delivery or receipt data
Location for each party as a proxy to determine degrees of interest based on immediacy of gaining access to those products
Value of previous transactions as a proxy to indicate propensity to purchase or sell based on prior financial commitments
   For example:

| | Shipment/receipt | | | Degree of |
|---|---|---|---|---|
| Product type | history | Location | Value | similarity |
| Same | On-time | Within 25 | US$1000 | High |
| | | miles | | |
| Same | Late | Within 200 | US$1000 | Limited |
| | | miles | | |
| Similar | On-time | Within 10 | US$1MM | Medium |
| | | miles | | |
| Different | Late | Not available | US$5000 | Inconsistent |

| Degree of past behavior | Score |
|---|---|
| High | 2 |
| Medium | 1 |
| No similarity | 0 |
| Limited | −1 |
| Inconsistent | −2 |

Past behavior score = −1
Updated relevance score = 11.9 + (−1) = 10.9

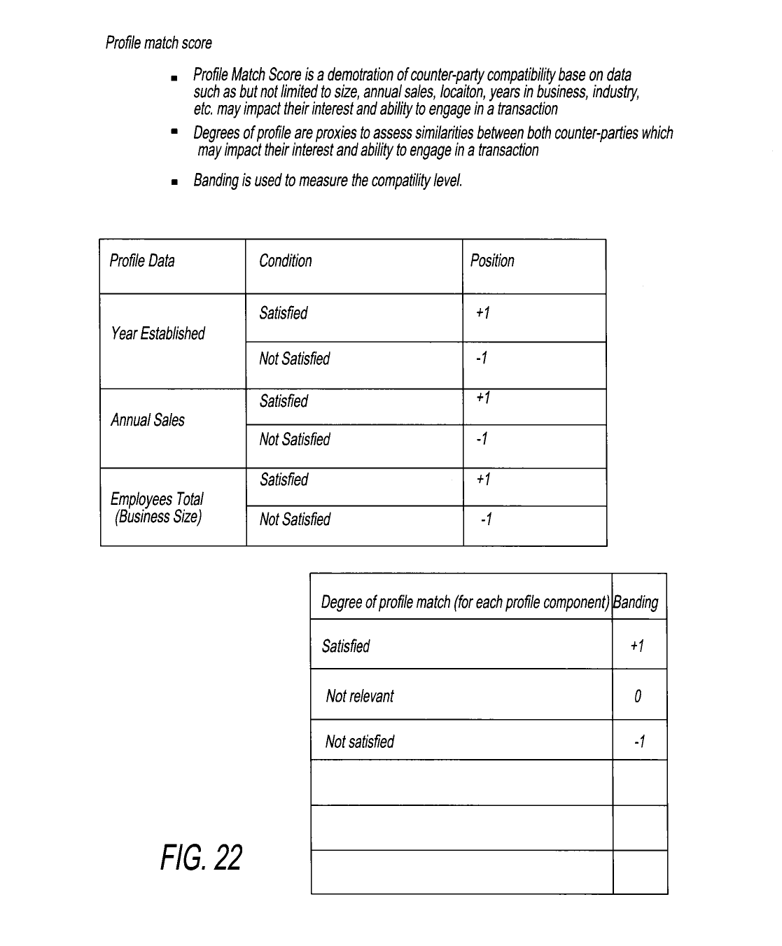

As shown in FIG. 22 and step 1316 of FIG. 13, the Profile Match Score is a demonstration of counter-party or candidate compatibility based on data, such as, but not limited to, size, annual sales, years in business, industry, etc. Degrees of profile are proxies to assess similarities between both counter-parties or candidates which may impact their interest and ability to engage in a transaction.

| Characteristic | Criteria | Status | Score |
|---|---|---|---|
| Years in business | Greater than 5 years | Not satisfied | −1 |
| Years in business | Within 5 years | Satisfied | +1 |
| Annual sales | More than | Not satisfied | −1 |
| | US$1MM difference | | |
| Annual sales | Less than | Satisfied | +1 |
| | US$1MM difference | | |
| Industry | Different market focus | Not satisfied | −1 |
| Industry | Same market focus | Satisfied | +1 |

Profile match score: 1 + 1 + 1 = 3
Updated relevance score = 10.9 + 3 = 13.9

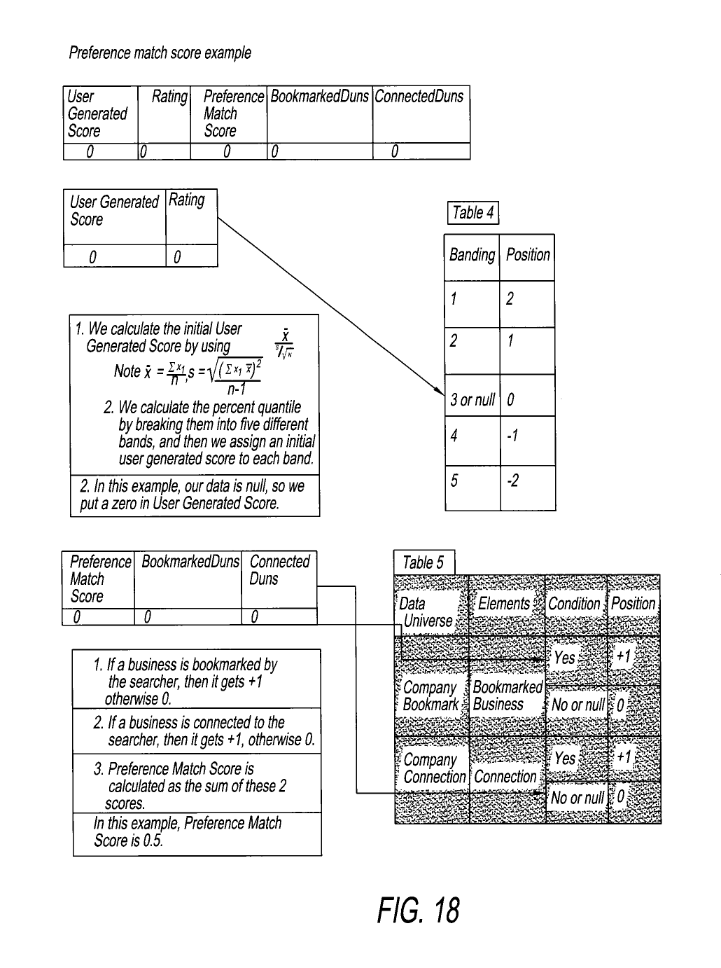

As shown in FIG. 18 and step 1318 of FIG. 13, the Preference Match Score is based on the degree of historical interactions between the two counter-parties or candidates based on previous transactions in which each party has been a counter-party or candidate for the same transaction, as a proxy to indicate likely interest in transacting with that party again; for example one acted as a buyer and one acted as a seller. This includes criteria such as interested products, price range, etc. This may also include the use of “bookmarks” by which one party may have previously indicated an interest in the counter-party or candidate based on prior transaction experiences.

This score has two components: (1) calculate the degree of transactional history between the two parties, and (2) determine if either party has indicated a preference to transact with that party again based on “bookmarks”.

Calculation of transactional history:

| | |
|---|---|
| Significant history (e.g., more than 10 transactions) | 3 |
| Limited history (e.g., between 5 and 9 transactions) | 2 |
| Minimal history (between 1 and 4 transactions) | 1 |
| No history (0 transactions) | 0 |
| Significant positive interest (from party 1) | 2 |
| Significant negative interest (from party 1) | −2 |
| No stated interest (from party 1) | 0 |
| Significant positive interest (from party 2) | 2 |
| Significant negative interest (from party 2) | −2 |
| No stated interest (from party 2) | 0 |

Determination of interest based on “benchmarks”
Preference match score: 2 + 2 + 0 = 4
Updated relevance score = 13.9 + 4 = 17.9

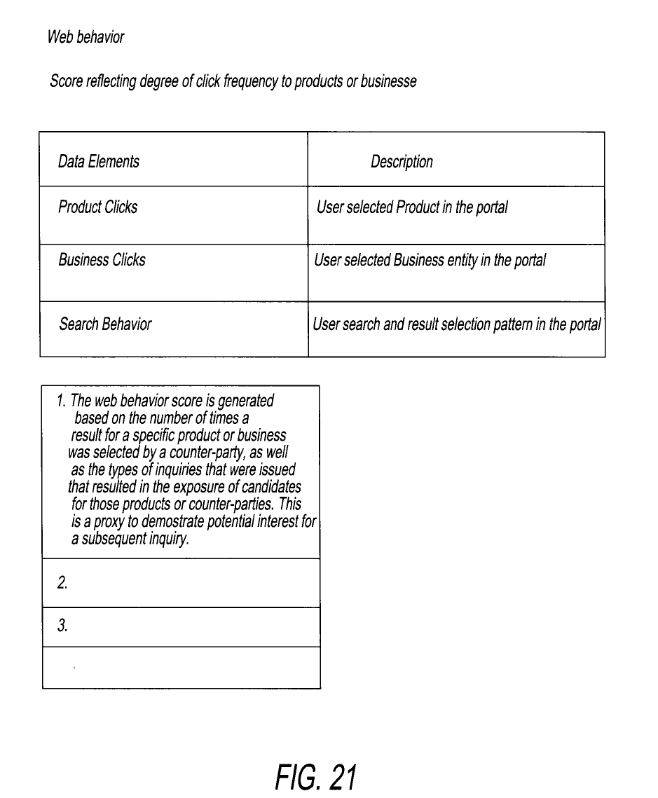

As shown in FIG. 21 and step 1320 of FIG. 13, a Web-behavior Score relates to previous experiences that each counter-party or candidate has had in prior searches or transactions, as evidenced in terms of product clicks, business clicks, or other web-enabled activity. This is a proxy for level of interest in the counter-party or candidate or the product based on prior behavior and as evidenced by business clicks, product clicks, etc.

| | |
|---|---|
| More than 10 product clicks as seller | 1 |
| Less than 10 product clicks as seller | 0 |
| More than 10 product clicks as buyer | 1 |
| Less than 10 product clicks as buyer | 0 |
| More than 10 clicks as party of interest as buyer | 1 |
| Less than 10 clicks as party of interest as buyer | 0 |
| More than 10 clicks as party of interest as seller | 1 |
| Less than 10 clicks as party of interest as seller | 0 |

Web behavior score: 0 + 1 = 1
Updated relevance score = 17.9 + 1 = 18.9

As shown in step 1322 of FIG. 13, a final relevance score is calculated for each candidate, wherein the exact calculation is based on other logic that may be applied to the calculated value such as to assign a classifying band to the score such as red/yellow/green, high/medium/low or other numeric or non-numeric classification. This value would be used to sequence all results for a single inquiry as initiated in step 1300 to determine the order in which the results should be presented back to the initial inquiry.

| Final relevance score range | Baseline relevance score |
|---|---|
| 5-10.9 | Low |
| 11-16.9 | Medium |
| 17-20 | High |

What is claimed is:

1. A method for generating a relevance score for at least one candidate retrieved in a search, said method comprising:
initiating a query seeking at least one said candidate based upon at least one filter selected from the group consisting of: product name, product category, company name, HS code, SIC code and any other product-related qualifier;
searching at least one database for matches between said candidate and said filter, thereby generating at least one matched candidate;
generating an initial relevance score for each said matched candidate;
generating at least one additional score for each said matched candidate, wherein said additional score is at least one selected from the group consisting of: a reputation score, a score boost, a past behavior score, a profile match score, a preference match score and a web behavior score; and
generating a final relevance score based upon said initial relevance score and said at least one additional score for each said matched candidate.

2. The method according to claim 1 further comprising: outputting a listing of said matched candidates with said final relevance scores.

3. The method according to claim 2 further comprises: sorting said listing of said matched candidates according to said relevance score.

4. The method according to claim 1, wherein said candidate is a buyer, further comprising passing said matched candidate through a look alike engine prior to generating said initial relevance score for said matched candidate.

5. The method according to claim 1, wherein said searched database is at least one selected from the group consisting of: objectively assessed business entity data, application data that is accumulated for the specific use of this application, and data from other sources with associated product and other codes.

6. The method according to claim 1, wherein said initial relevance score is generated from a search engine which used to identify said candidates based on said filter.

7. The method according to claim 1, wherein said score boost is determined by the objective assessment as the operational and financial quality and a party which initiates said query and/or said candidate and each said party and/or candidate's status of registration within the application that is used to process said queries.

8. The method according to claim 1, wherein said reputation score is determined by at least one score selected from the group consisting of: a commercial credit score, a financial stress score, and detail trade.

9. The method according to claim 1, wherein said preference match score is calculated by the sum of a first score which is determined by whether a business is bookmarked (1) or not (0), and a second score which is determined by whether the business is connected to the business which has initiated said query, and results in a value of +1 or 0.

10. The method according to claim 1, wherein said past behavior score is based upon said matched candidate's shipment volume.

11. The method according to claim 1, further comprising a step of generating a relevance index for each candidate prior to the step of generating said initial relevance score.

12. A computer readable storage media containing non-transitory computer executable instructions which when executed cause a processing system to perform a method comprising:
initiating a query seeking at least one said candidate based upon at least one filter selected from the group consisting of: product name, product category, company name, HS code, SIC code and any other product-related qualifier;
searching at least one database for matches between said candidate and said filter, thereby generating at least one matched candidate;
generating an initial relevance score for each said matched candidate;
generating at least one additional score for each said matched candidate, wherein said additional score is at least one selected from the group consisting of: a reputation score, a score boost, a past behavior score, a profile match score, a preference match score and a web behavior score; and
generating a final relevance score based upon said initial relevance score and said at least one additional score for each said matched candidate.

13. A system for providing enhanced matching for database queries, the system comprising:
a processor; and
a memory that contains a program that cause said processor to:
initiate a query seeking at least one said candidate based upon at least one filter selected from the group consisting of: product name, product category, company name, HS code, SIC code and any other product-related qualifier;
search at least one database for matches between said candidate and said filter, thereby generating at least one matched candidate;
generate an initial relevance score for each said matched candidate;
generate at least one additional score for each said matched candidate, wherein said additional score is at least one selected from the group consisting of: a reputation score, a score boost, a past behavior score, a profile match score, a preference match score and a web behavior score; and
generate a final relevance score based upon said initial relevance score and said at least one additional score for each said matched candidate.
